(19) United States
(12) Patent Application Publication
(10) Pub. No.: US 2025/0355643 A1
(43) Pub. Date: Nov. 20, 2025

(54) Artificial Intelligence-Guided Application Development

(71) Applicant: Formagrid Inc, San Francisco, CA (US)

(72) Inventors: Selena Wang, San Jose, CA (US); Tor-Helge Persett, Seattle, WA (US); Kevin Jonathan Kuo, Brooklyn, NY (US); Adrianne Claire Ngam, San Francisco, CA (US); Vivian Hare, Pleasanton, CA (US); Bridger Maxwell, Brooklyn, NY (US); Mojtaba Mehrara, San Francisco, CA (US); Kelly O'Shaughnessy, New York, NY (US)

(21) Appl. No.: 19/210,490

(22) Filed: May 16, 2025

Related U.S. Application Data
(60) Provisional application No. 63/648,568, filed on May 16, 2024.

(51) Int. Cl. G06F 8/35; G06F 16/3329; G06F 16/81

(52) U.S. Cl. CPC G06F 8/35; G06F 16/33295; G06F 16/81

(57) ABSTRACT

A system receives a free text description of functionality desired for an application. The system creates first prompt including the free text description and a first request for a set of recommended components for the application. The system inputs the first prompt to a first generative language model and receives, as output, the set of recommended components for the application. The system generates a set of pages for at least a subset of the set of recommended components using a second generative language model. The system generates a schema for each page, where schema a defines a structure for storing data related to the respective page. The system determines a set of resources to include in each page. The system generates the application with the pages, the schemas, and the resources and provides access to the application to a client device.

### CROSS REFERENCE TO RELATED APPLICATIONS

This application claims the benefit of U.S. Provisional Application No. 63/648,568, filed May 16, 2024, which is incorporated by reference in its entirety.

### BACKGROUND

### 1. Technical Field

The subject matter described relates generally to artificial intelligence (AI) and, in particular, to using AI to guide a user through creating an application.

### 2. Background Information

Online platforms often provide applications (or “apps”) that provide specific functionality for the platform. For example, one app might generate an organization chart for an enterprise while another might provide access to sales and profitability data without needing to provide the end users with access to the underlying database. Thus, apps can provide an efficient way to provide functionality to end users while limiting what those end users can see or modify. However, building a new app from scratch is often time consuming and complex. Large enterprises may have vast amounts of data and many different existing views and permission sets for that data. There is thus a need for tools to aid users in building new apps with desired functionality.

### SUMMARY

An AI-driven user interface can be used to guide a user through the app creation process. The AI can include a combination of a large language model (LLM), an embedding model, and heuristics. The process may be broken down into manageable subparts. In one embodiment, the subparts include using a large language model (LLM) to identify recommended objects to include in the app, using an embedding model with heuristics to identify relevant components (e.g., icons and table units), generating schemas for selected objects (and defining any relevant relationships between objects), and recommending pages to include in the app. The output from each subpart may be converted into a standardized schema that can be used to generate a preview of the application for user modification and approval. Once approval is received, the subpart outputs in the standardized schema (with any modifications made during the preview process) may be converted into a set of primitives (e.g., JSON primitives) that may be used to build the app.

In some embodiments, a system receives a free text description of functionality desired for an application. The system creates a first prompt including the free text description and a first request for a set of recommended components for the application. The system inputs the first prompt to a first generative language model and receives, as output, the set of recommended components for the application. The system generates a set of pages for at least a subset of the set of recommended components using a second generative language model. The system generates a schema for each page. Each schema a defines a structure for storing data related to the respective page. In some embodiments, the system uses a third generative language model to generate the schemas. The system determines a set of resources to include in each page. The system generates the application with the pages, the schemas, and the resources and provides access to the application to a client device.

### BRIEF DESCRIPTION OF THE DRAWINGS

FIG. 1 is a block diagram of a networked computing environment in which apps may be built and deployed, according to one embodiment.

FIG. 2 is a block diagram of the server of FIG. 1, according to one embodiment.

FIGS. 3A and 3B are a first flowchart of a method for building an app, according to one embodiment.

FIG. 4 is a flowchart of dataflow for an LLM when building an app, according to one embodiment.

FIG. 5 illustrates a flowchart of a method for providing access to an application, according to one embodiment.

FIG. 6 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

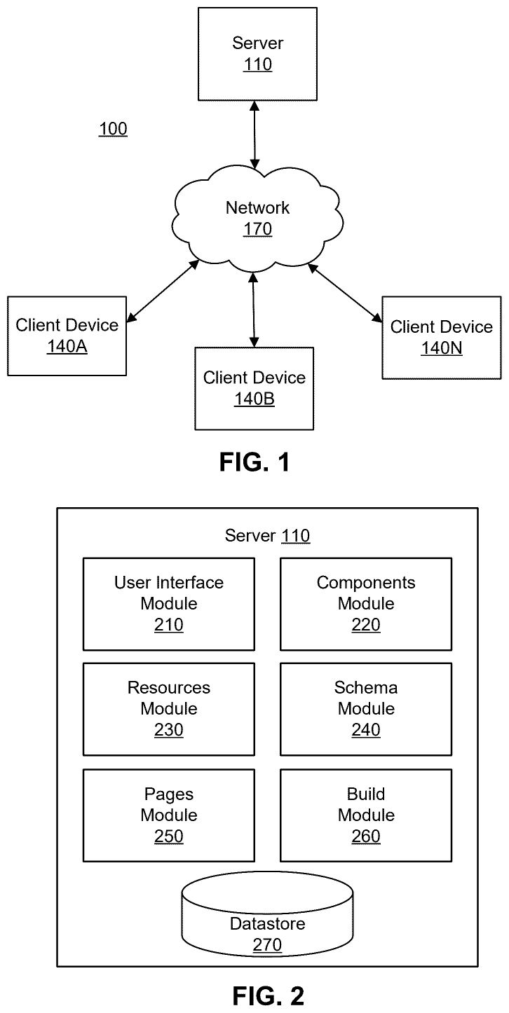

FIG. 1 illustrates one embodiment of a networked computing environment 100 in which apps may be built with an AI-guided process. In the embodiment shown, the networked computing environment 100 includes a server 110 and a set of client devices 140, all connected via a network 170. In other embodiments, the networked computing environment 100 includes different or additional elements. In addition, the functions may be distributed among the elements in a different manner than described.

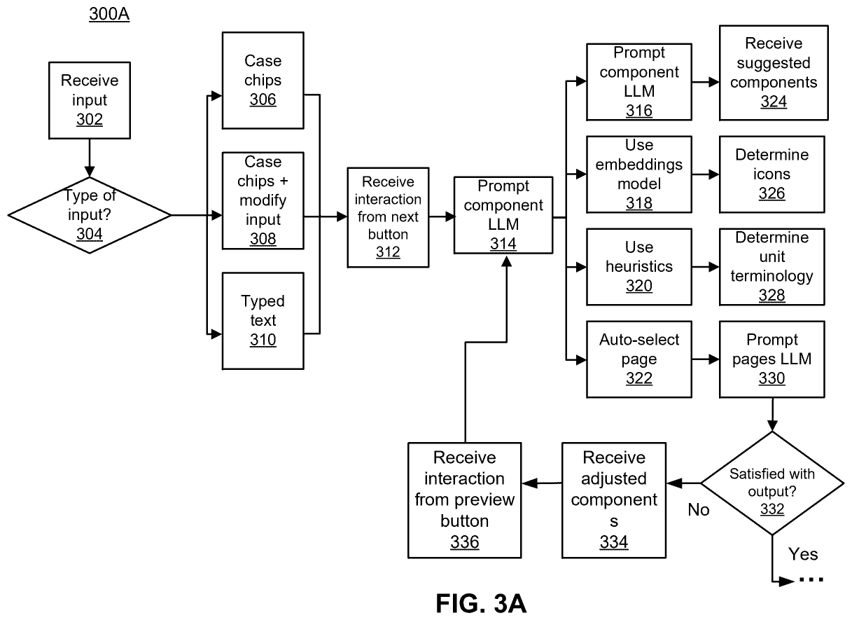

The server 110 includes one or more computing devices that store data that may be interacted with by users via one or more of the client devices 140. In one embodiment, the server 110 stores databases for users that can be interacted with via various views, apps, and automations. The server 110 also provides an AI-driven interface with which users can build new apps to meet their needs. The interface can make use of one or more LLMs and heuristics to dynamically suggest business objects, resources, and pages to include in an application. The server 110 may also perform automatic error correction on the suggestions generated by the AI components, thus reducing the amount of work needed by the user to build a new app. Various embodiments of the server 110 are described in greater detail below, with reference to FIG. 2.

The client devices 140 are one or more computing devices with which users may interact with the server 110. Although three client devices 140 are shown (a first client device 140A, a second client device 140B, and an Nth client device 140N), the networked computing environment 100 may include any number of such devices. In one embodiment, a client device 140 provides a user interface with which a user can access data stored at the server 110 as well as design, build, and use apps. The user interface may be provided by a dedicated application (e.g. that interacts with the server 110 via an API) or in a web browser that displays an interface webpage provided by the server 110.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes a user interface module 210, a components module 220, a resources module 230, a schema module 240, a pages module 250, a build module 260, and a datastore 270. In other embodiments, the server 110 includes different or additional elements. In addition, the functions may be distributed among the elements in a different manner than described.

The user interface module 210 provides user interfaces that may be accessed by users at client devices 140 to interact with the server 110. In one embodiment, a user interface provides a workflow with which the user may create a new app. On selection of an option (e.g., by clicking on a button or other control in the interface) to create a new app, the user is prompted to provide a free text description of the functionality desired for the app. The user interface module 210 sends free text descriptions to the components module 220 and may store the free text descriptions in the datastore 270.

The components module 220 selects one or more components (e.g., entity objects) to recommend for the app based on the free text description provided by the user. A component may be a digital representation of a real-world thing or concept and may be managed, tracked, or processed via an application. Each component may be related to an entity that handles the component. For example, a construction company may be an entity that handles contracts for construction projects. In another example, a data storage company may be an entity that maintains a data structure. Other examples of components include schedules, invoices, records, projects, tasks, deadlines, orders, assessments, and the like.

The components module 220 receives free text descriptions (e.g., from the user interface module 210). For each free text description, the components module 220 builds a prompt asking for suggested components in view of the free text description. In some embodiments, the components module 220 accesses information about a user who provided the free text description based on an identifier of the user received with the free text description and includes the information about the user in the prompt. The component module 220 inputs the prompt to a component LLM that generates a set of recommended components. In some embodiments, the component LLM also generates a likelihood of selection for each recommended component in the set or the likelihoods are determined by heuristics based on prior usage of components by the user or other users. The components module 220 may split the set of recommended components into two or more groups based the likelihoods. In some embodiments, the components module 220 may select components in a first group that includes components with the highest likelihoods of the set and automatically add the components to the application.

The components module 220 may send components in the other groups to the user interface module 210 for presentation in a user interface, such that the user can select components for inclusion in the application via the user interface. For example, the components module 220 may automatically add a first group of components to the app to build a skeleton (e.g., the basic minimal structure) of the app and send a second group to the user interface module 210 for presentation to the user, such that a user may select one or more components to add to the first group. The components module 220 sends the components selected for inclusion in the app to one or more other modules, such as the resource module 230, schema module 240, or pages module 250, for a design phase of the application. For instance, the components module 220 may send the selected components to each of the resources module 230, schema module 240, and pages module 250 or may send the selected components to one of the aforementioned modules, which sends the selected components to a next aforementioned module and so forth. The components module may also store the components in association with identifiers in the datastore 270.

The pages module 250 receives components that were selected by the components module 220 and selects pages to be included in the app. A page is a visual and functional assembly that brings together schemas, components, and resources to deliver a specific user experience or function. In some embodiment, a page may include one or more visualizations for data and icons such as lists, galleries, timelines, calendars, etc. In some embodiments, the pages module 250 creates a prompt with the selected components and a request for one or more pages for each selected component. The pages module 250 may input the prompt to a pages LLM and receive one or more pages from the pages LLM. In some embodiments, the pages LLM outputs the pages in groups representing logical sections of pages for the application. The pages module 250 stores each page output by the pages LLM in association with an identifier of a respective component in the datastore 270. The pages module sends the pages to the resource module 230 and schema module 240.

The resource module 230 receives the pages selected by the pages module 250 and the corresponding selected components and identifies one or more resources to include in the app based on the pages and corresponding selected components. Resources are the assets and data structures that the app will use display, or manage. Resources may include icons, table units, and visualizations for data. Icons are small graphic symbols that represent actions, objects, or states in the app. Table units are structured chunks of data that the app displays, edits, or stores in tables. For example, each row in a table may be considered a table unit that represents a component. Each resource may be associated with a location within a corresponding page at which the resource will be located for viewing.

The resource module 230 may use an embedding model to identify the resources to include in the app. The embedding model may be a machine learning model that converts input data, such as a list of selected components, into dense vectors of numbers (e.g., embeddings) that capture meaningful relationships between inputs in lower-dimensional space. The resource module 230 may use the embeddings model to generate an embedding representing each of the selected components, the pages, and each of a list of resources that can be used in applications. For each selected component, the resource module 230 may compare the embedding of the selected component to the embeddings of each of the list of resources and select a resource to use for the component based on the embedding of the resource having the highest level of similarity of the resource embeddings to the embedding of the selected component.

In some embodiments, the resource module 230 uses an LLM to generate the resources, similar to the processes described in relation to the components module 220 and pages module 250. In some embodiments, the resource module 230 may use heuristics to select resources to include in the app. Each heuristic may be rules or shortcuts that are used to decide resources to use in the app. For example, the resource module 230 may use a heuristic that defines to include a signature icon for any component that is a contract. The resource module 230 may store each resource in association with identifiers of respective pages and components in the datastore 270.

The schema module 240 generates a schema for each page and associated business object. Each schema is a structure that defines how an associated business object is represented, organized, and interacted with in the application. The schema may define: attributes of the page; relationships between the page, its selected component(s), and other pages and components; operations that can be or have been done for the page; and presentation details for presenting the page in a user interface. In one embodiment, the schema module 240 generates schemas in a standardized format that can be used to efficiently generate previews of the app as components are added and removed.

In some embodiments, the schema module 240 receives pages selected by the pages module 250 and generates a schema for each page. Each schema defines the shape, content, and behavior of the corresponding page. For example, a schema may be a structured definition that describes what a page is (e.g., identity and purpose), what properties the page has (e.g., data and fields), what relationships the page has to other pages, what actions or behaviors the component supports (e.g., what the component can do), and what rules apply to the page (e.g., validation, constraints, permissions, etc.). The schema module 240 may generate a prompt that requests a schema for each page. The schema module may include resources associated with each page, as accessed from the datastore 270, in the prompt. The schema module 240 may input the prompt to a schema LLM, which is trained to provide a schema for each page. In some embodiments, the schema LLM may also generate examples for a respective page and define relationships between pages selected for inclusion in the app. The schema modules 240 may store each schema (and examples) output by the schema LLM in association with an identifier of a respective page in the datastore 270. The schema module 240 can send an indication that the design phase for the application has ended to the user interface module 210. The indication may include the identifiers of the pages.

In each of the uses of an LLM described above, the prompt (also referred to as a query) to each LLM is structured to improve the probability of receiving useful outputs. In some embodiments, interactions with one or more LLM use a dedicated JSON-based domain specific language (DSL). In other words, the relevant module asks the relevant LLM to respond in an appropriate schema. Each type of prompt (e.g., the prompts generated by each module) may have its own schema. For example, when asking for components to include, the schema used is different than the schema used when requesting resources associated with pages.

In each case where an LLM is used, there is the possibility of the output from the LLM including one or more errors. This can be partially addressed with techniques including reducing complexity where possible (e.g., a respective module making the response shape of the specific prompt as close as possible to a desired result), modifying a schema to accommodate a pattern of mistake (e.g., if a particular request type keeps generating responses in a schema that differs from the one intended, the intended schema can be updated to match the outputs already being generated), and making use of an LLM's a priori knowledge wherever possible (e.g., if something is fundamentally a general data model problem, lower-powered LLMs typically produce better results when the request of the prompt is framed more generally rather than a platform-specific request). It should be appreciated that a range of other prompt engineering techniques may be used to improve the quality of results generated by the LLMs and that one or more of the modules described in relation to the server 110 may apply the various techniques to address errors.

Mistakes made by the LLMs can additionally or alternatively be fixed by the one or more modules of the server 110 in post-processing. For example, minor problems may be fixed in memory, such as inferring missing options in a generated schema and adding it automatically, dropping values that are not in an expected format (e.g., where a date value is not in ISO format), ignoring objects of types not expected to be included in a schema (e.g., images), etc. If the mistakes in a schema generated by an LLM are too large to fix, the LLM may be prompted to try again, providing the previous response and an indication of the errors as context. This may be attempted a predetermined number of times (e.g., three) before reporting a failure to the user interface module 210, which presents a request for the user to update a prompt or generate a schema manually.

In one embodiment, the user interface module 210 receives indications from the pages module 250, where each indication is indicative of a design phase ending. In response to receiving an indication, the user interface module 210 accesses the components, schemas, resources, and pages (henceforth collectively referred to as objects) associated with the identifiers in the indication from the datastore 270. The user interface module 210 renders one or more user interfaces including pages for the application including/based on the other accessed objects. The user interface module 210 causes a client device 140 to present the one or more user interfaces such that a user can preview and edit the pages at the client device 140. In response to receiving edits from a client device, the user interface module 210 sends the edits with the previous free text description to the components module 220 to initiate a new design phase with prompts including the edits. Once the user interface module 210 receives an indication of approval of the preview from the client device 140, the user interface module 210 sends the identifiers of the pages to the build module 260.

The build module 260 receives the identifiers of the pages from the user interface module 210, accesses the objects associated with the pages in the datastore 270, and uses the objects to build the app. In one embodiment, the build module 260 converts the schemas into a set of JSON primitives (e.g., ColumnJSON etc.) that can then be used to build the app to be populated with the desired resources, such as tables, columns, rows, interfaces, and the like.

The datastore 270 includes one or more non-transitory computer-readable media that store the data used by the other components of the server 110. For example, the datastore may include the various objects and apps generated by the server 110 along with the underlying data for those apps. Although the datastore 270 is shown as a single entity within the server 110, in some embodiments, the datastore 270 is split across multiple storage media, some or all of which may be located remotely from the server 110 (e.g., as a distributed database).

### Example Methods

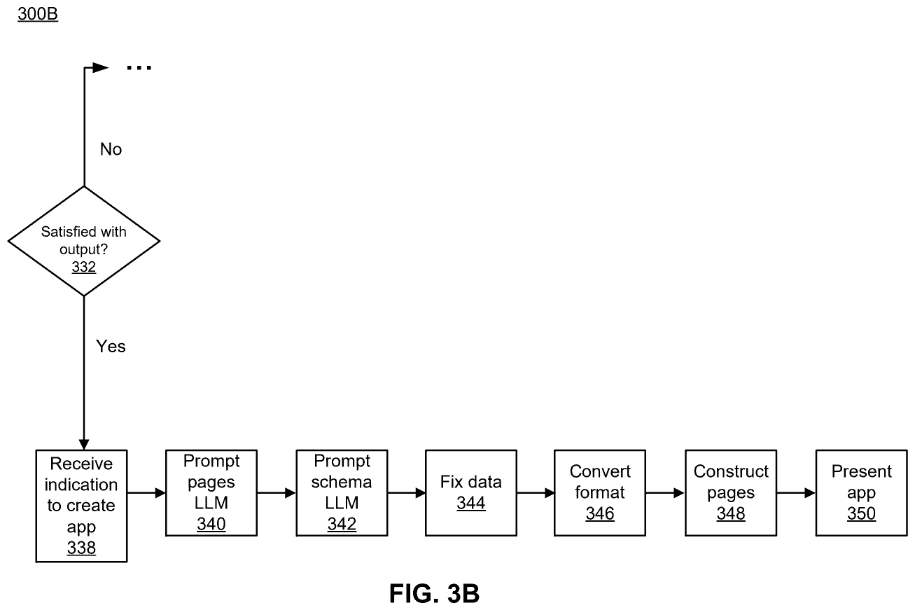

FIGS. 3A-B illustrate a method for building an app, according to one embodiment. The steps of FIGS. 3A-B are illustrated from the perspective of the server 110 performing the method. However, some or all of the steps may be performed by other entities or components. In addition, some embodiments may perform the steps in parallel, perform the steps in different orders, or perform different steps.

In the embodiment shown, the method 300A begins by prompting the user at a client device 140 to describe what the app is being built for and who will be using it. The server 110 receives 302 an input from a client device 140 and determines 304 a type of input provided. The types of input may be in the form of case chips 306 (e.g., interactive elements representative of text), case chips that have been added to or modified 308, or typed text 310 (e.g., a free text input). Regardless of the type of input, once the server 110 receives 312 an interaction from a next button, the server 110 uses the app description in a prompt (e.g., “take app description and convert to list of components”) for the component LLM 314, which outputs a list of initial objects (e.g., the components). The server 110 may also prompt 316 the component LLM using a prompt requesting suggested components based on the app description and receive 324 a list of suggested components to add to the initial objects. The server 110 determines resources using 318 the embeddings model to determine 326 relevant icons and using 320 heuristics to determine 328 unit terminology. In the embodiment shown, the server 110 also auto-selects 322 a first page to include and prompts 330 the schema LLM (e.g., “get table schema and examples for selected table”) to generate schemas for the first page. In some embodiments, the server 110 generates the schemas using a prompt that does not include an auto-selected page.

The user interface module 210 may cause the client device 140 to display a preview of the app and an interactive prompt for a user to enter whether they are satisfied with the output 332. If the user indicates they are not satisfied via the interactive prompt, the user interface module 210 may cause the client device 140 to present the objects generated in the method 300A such that the user can adjust the components. The server 110 receives 334 the adjusted components and receives 336 an interaction from a previous button indicative of the user's desire to preview the app using the adjusted objects. The method 300A iterates until the user indicates they are satisfied via a user interface. At that point in the method 300B, the user elects to generate the app, and the server 110 receives 338 an indication to create the app. The server 110 prompts 340 the schema LLM (e.g., “get table schema and examples for selected table”) to get schemas and examples for the selected components and prompts 342 the t pages LLM (e.g., “determine proper visualization pages (list, gallery, calendar, timeline++) for all of the components at once”) to determine the proper pages for all of the components selected. The server 110 may fix 344 the generated data (e.g., by fixing errors), convert 346 the app from a preview format a final format, and use heuristics to construct 348 interface screens for the various included pages. At this point, the app is ready for use.

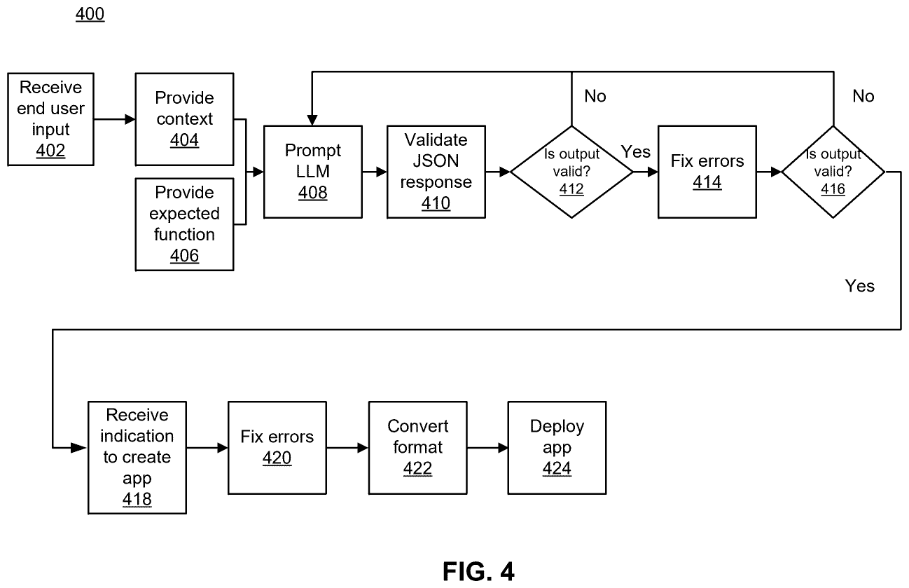

FIG. 4 illustrates the dataflow for an LLM when building an app, according to one embodiment. The steps of FIG. 4 are illustrated from the perspective of the server 110 performing the method. However, some or all of the steps may be performed by other entities or components. In addition, some embodiments may perform the steps in parallel, perform the steps in different orders, or perform different steps. Further, the following description pertains to general use of an LLM and may be used for the component LLM, pages LLM, and schema LLM.

In the embodiment shown in FIG. 4, the method 400 begins with receiving 402 input from an end user. The server 110 provides 404 context in the form of previous flow steps as substituted arguments in prompts given to the LLM and provides 406 an expected function calling a JSON schema for the response provided by the LLM. The server 110 prompts 408 the LLM. For example, the prompt may indicate to “Get the schema and examples for a selected table.” The server 1120 validates 410 the JSON response received from the LLM to determine 412 whether the output is valid. This validation may be more permissive than the original JSON schema provided with the expected function to allow some flexibility in how the LLM generates responses where that flexibility does not substantially impact the result of the LLM. If the output is still determined to be invalid (even under the possibly more permissive standard), the LLM is prompted 408 again to provide the desired output. Conversely, if the output is valid, the server 110 attempts to fix 414 any errors in the schema or examples that did not cause validation to fail and then performs a stricter validation test. The server determines 416 whether the JSON output after fixing errors is valid. If the fixed up JSON output fails the stricter validation step, the LLM is prompted 408 again and the process repeats. Conversely, if the JSON output passes the stricter validation step, the generated data is used to power the user interface for app setup (e.g., by generating a preview of the app for presentation to the user).

Once the user is satisfied with the previewed app, the server 110 receives an indication to create the application and fixes 420 additional errors as needed. For example, the server 110 may ensure table relationships are correct, column requirements are met, and any applicable data rules are strictly complied with. The server 110 converts the schema used for setup/preview of the app into a general format that is used to build the app, which can then be deployed 424 by the user.

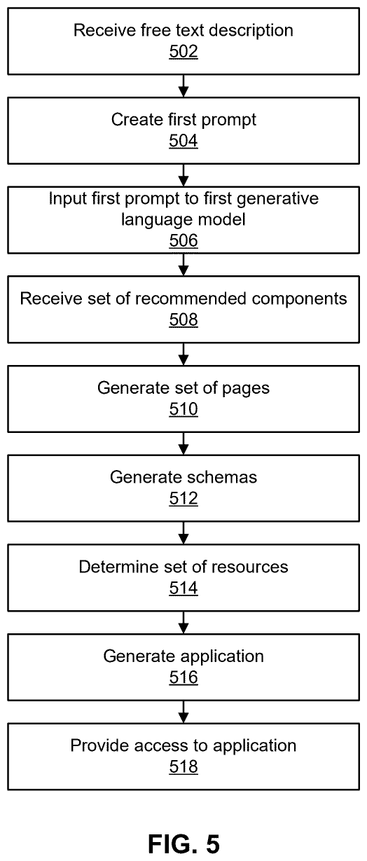

FIG. 5 illustrates a flowchart of a method 500 for providing access to an application, in accordance with one or more embodiments. In some embodiments, additional or alternative components those described in relation to FIG. 5 may be used to perform the method 500. Further, additional or alternative steps to those described in relation to FIG. 5 may be included in the method 500.

In the embodiment shown, the method 500 begins with the user interface module 210 receiving 502, from a client device 140 associated with a user, a free text description of functionality desired for an application. The user interface module 210 sends the free text description to the components module 220, which creates 504 a first prompt including the free text description and a first request for a set of recommended components for the application. The components module 220 inputs 506 the first prompt to a first generative language model (e.g., the component LLM). The components module 220 receives 508, from the first generative language model, the set of recommended components for the application. In some embodiments, the components module 220 sends the set of recommended components to the user interface module 210 for presentation to the user, such that the user can select a subset of the set of recommended components to include in the application.

The components module 220 sends the set of recommended components to the pages module 250, which generates 510 a set of pages for at least a subset of the set of recommended components using a second generative language model (e.g., pages LLM). In some embodiments, the pages module 250 creates a second prompt including the at least a subset of the set of recommended components for the application and inputs the second prompt to the second generative language model. The pages module 250 receives, from the second generative language model, the set of pages including a page for each recommended component included in the second prompt. The pages module 250 sends the pages to the schema module 240.

The schema module 240 generates 512 a schema for each page received from the pages module 220. Each schema a defines a structure for storing data related to the respective page. In some embodiments, the schema module 240 creates a third prompt including the set of pages and a third request for the schema for each of the set of pages and inputs the third prompt to a third generative language model (e.g., schema LLM). The schema modules 240 receives, from the third generative language model, a schema associated with each page. The schema module 240 sends the schemas to the resources module 230. The resources module 230 determines 514 a set of resources to include in each page, and the resources include one or more visualizations. The build module 260 generates 516 the application with the pages, the schemas, and the resources and provides 518 access to the application to the user at the client device 140.

In some embodiments, each resource is an icon and the resource module 230 users an embeddings model to determine the resources. The resource module 230 may apply the embeddings model to the set of pages and select, for each page, at least one icon with an embedding within a threshold level of similarity to the page. In some embodiments, the user interface module 210 causes the client device 140 to present a preview of the application. In response to receiving an indication that the user does not approve of the application, the user interface module 210 causes the client device to present the set of recommended components (or the pages) with one or more interactive elements each capable of receiving an interaction indicative of modification to one of the set of recommended components (or pages). The components module 220 creates a new prompt for the first generative language model, where the new prompt includes the free text description, any modifications received for the set of recommended components, and a request for a new set of recommended components. The components module 220 inputs the new prompt to the first generative language model.

In some embodiments, the resources include unit terminologies and the resources module 230 determines resources for the application using one or more heuristics. In some embodiments, the outputs received from each generative language model (e.g., LLM) are JSON responses. In some embodiments, the same generative language model is used for the first, second, and third generative language models. For each output, the build module 260 validates the JSON response based on a first response schema. In response to the JSON response being valid, the build module 260 corrects errors in the JSON response. The build module 260 may validate the corrected JSON response based on a second response schema, which is stricter than the first response schema.

### Computing System Architecture

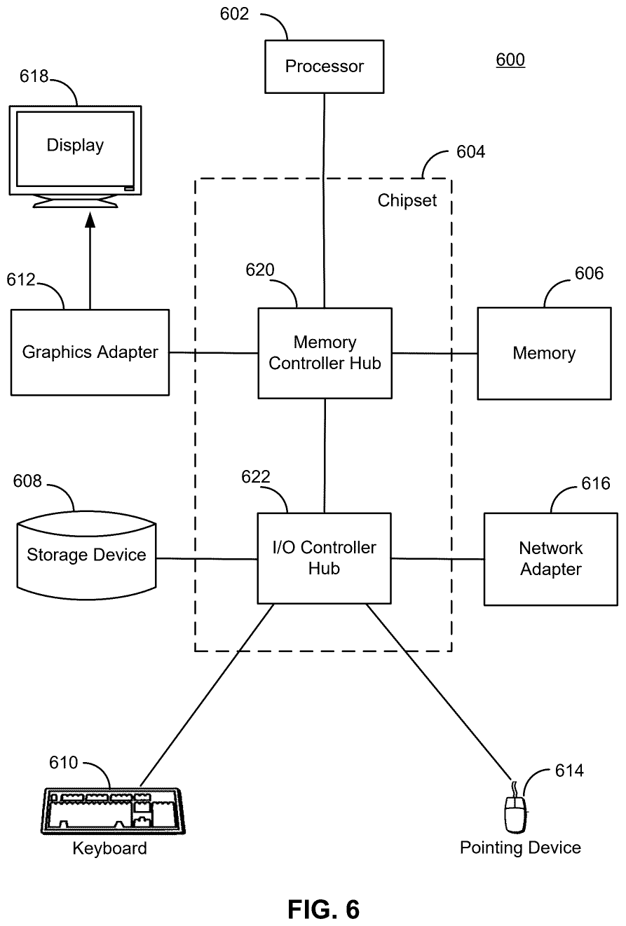

FIG. 6 is a block diagram of an example computer 600 suitable for use as server 110 or client device 140. The example computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 170.

The types of computers used by the entities of FIGS. 1 and 2 can vary depending upon the embodiment and the processing power required by the entity. For example, the server 110 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method comprising:
receiving, from a client device associated with a user, a free text description of functionality for an application;
creating a first prompt including the free text description and a first request for a set of recommended components for the application;
inputting the first prompt to a first generative language model;
receiving, from the first generative language model, the set of recommended components for the application;
generating a set of pages for at least a subset of the set of recommended components using a second generative language model;
generating a schema for each page, wherein each schema a defines a structure for storing data related to the respective page;
determining a set of resources to include in each page, wherein the resources include one or more visualizations;
generating the application with the pages, the schema for each page, and the set of resources; and
providing access to the application to the client device.

2. The method of claim 1, wherein generating the set of pages for the at least a subset of the set of recommended components using the second generative language model comprises:
creating a second prompt including the at least a subset of the set of recommended components for the application;
inputting the second prompt to the second generative language model; and
receiving, from the second generative language model, the set of pages including a page for each recommended component included in the second prompt.

3. The method of claim 2, wherein generating the schema for each page comprises:
creating a third prompt including the set of pages and a third request for the schema for each of the set of pages;
inputting the third prompt to a third generative language model;
receiving, from the third generative language model, the schema associated with each page.

4. The method of claim 1, wherein each resource is an icon, determining the set of resources to include in each page comprising:
applying an embeddings model to the set of pages; and
selecting, for each page, at least one icon with an embedding within a threshold level of similarity to the page.

5. The method of claim 1, further comprising:
causing the client device to present a preview of the application;
in response to receiving an indication that the user does not approve of the application:
causing the client device to present the set of recommended components with one or more interactive elements each capable of receiving an interaction indicative of modification to one of the set of recommended components;
creating a new prompt for the first generative language model, wherein the new prompt includes the free text description, any modifications received for the set of recommended components, and a request for a new set of recommended components; and
inputting the new prompt to the first generative language model.

6. The method of claim 1, wherein the resources are unit terminologies, the method further comprising:
determining unit terminologies for the application using one or more heuristics.

7. The method of claim 1, wherein the received set of recommend components for the application are in a JSON response, the method further comprising:
validating the JSON response based on a first response schema;
in response to the JSON response being valid, correcting errors in the JSON response;
validating the corrected JSON response based on a second response schema, wherein the second response schema is stricter than the first response schema.

8. A non-transitory computer-readable storage medium storing instructions that, when executed, cause a processor to perform steps comprising:
receiving, from a client device associated with a user, a free text description of functionality for an application;
creating a first prompt including the free text description and a first request for a set of recommended components for the application;
inputting the first prompt to a first generative language model;
receiving, from the first generative language model, the set of recommended components for the application;
generating a set of pages for at least a subset of the set of recommended components using a second generative language model;
generating a schema for each page, wherein each schema a defines a structure for storing data related to the respective page;
determining a set of resources to include in each page, wherein the resources include one or more visualizations;
generating the application with the pages, the schema for each page, and the set of resources; and
providing access to the application to the client device.

9. The non-transitory computer-readable storage medium of claim 8, wherein generating the set of pages for the at least a subset of the set of recommended components using the second generative language model comprises:
creating a second prompt including the at least a subset of the set of recommended components for the application;
inputting the second prompt to the second generative language model; and
receiving, from the second generative language model, the set of pages including a page for each recommended component included in the second prompt.

10. The non-transitory computer-readable storage medium of claim 9, wherein generating the schema for each page comprises:
creating a third prompt including the set of pages and a third request for the schema for each of the set of pages;
inputting the third prompt to a third generative language model;
receiving, from the third generative language model, the schema associated with each page.

11. The non-transitory computer-readable storage medium of claim 8, wherein each resource is an icon, determining the set of resources to include in each page comprising:
applying an embeddings model to the set of pages; and
selecting, for each page, at least one icon with an embedding within a threshold level of similarity to the page.

12. The non-transitory computer-readable storage medium of claim 8, the steps further comprising:
causing the client device to present a preview of the application;
in response to receiving an indication that the user does not approve of the application:
causing the client device to present the set of recommended components with one or more interactive elements each capable of receiving an interaction indicative of modification to one of the set of recommended components;
creating a new prompt for the first generative language model, wherein the new prompt includes the free text description, any modifications received for the set of recommended components, and a request for a new set of recommended components; and
inputting the new prompt to the first generative language model.

13. The non-transitory computer-readable storage medium of claim 8, wherein the resources are unit terminologies, the steps further comprising:
determining unit terminologies for the application using one or more heuristics.

14. The non-transitory computer-readable storage medium of claim 8, wherein the received set of recommend components for the application are in a JSON response, the steps further comprising:
validating the JSON response based on a first response schema;
in response to the JSON response being valid, correcting errors in the JSON response;
validating the corrected JSON response based on a second response schema, wherein the second response schema is stricter than the first response schema.

15. A system comprising:
a processor; and
a non-transitory computer-readable storage medium storing instructions that, when executed, cause the processor to perform steps comprising:
receiving, from a client device associated with a user, a free text description of functionality for an application;
creating a first prompt including the free text description and a first request for a set of recommended components for the application;
inputting the first prompt to a first generative language model;
receiving, from the first generative language model, the set of recommended components for the application;
generating a set of pages for at least a subset of the set of recommended components using a second generative language model;
generating a schema for each page, wherein each schema a defines a structure for storing data related to the respective page;
determining a set of resources to include in each page, wherein the resources include one or more visualizations;
generating the application with the pages, the schema for each page, and the set of resources; and
providing access to the application to the client device.

16. The system of claim 15, wherein generating the set of pages for the at least a subset of the set of recommended components using the second generative language model comprises:
creating a second prompt including the at least a subset of the set of recommended components for the application;
inputting the second prompt to the second generative language model; and
receiving, from the second generative language model, the set of pages including a page for each recommended component included in the second prompt.

17. The system of claim 16, wherein generating the schema for each page comprises:
creating a third prompt including the set of pages and a third request for the schema for each of the set of pages;
inputting the third prompt to a third generative language model;
receiving, from the third generative language model, the schema associated with each page.

18. The system of claim 15, wherein the first generative language model, second generative language model, and third generative language model are the same generative language model.

19. The system of claim 15, the steps further comprising:
causing the client device to present a preview of the application;
in response to receiving an indication that the user does not approve of the application:
causing the client device to present the set of recommended components with one or more interactive elements each capable of receiving an interaction indicative of modification to one of the set of recommended components;
creating a new prompt for the first generative language model, wherein the new prompt includes the free text description, any modifications received for the set of recommended components, and a request for a new set of recommended components; and
inputting the new prompt to the first generative language model.

20. The system of claim 15, wherein the resources are unit terminologies, the steps further comprising:
determining unit terminologies for the application using one or more heuristics.
